(19) United States
(12) Patent Application Publication
(10) Pub. No.: US 2019/0168805 A1
(43) Pub. Date: Jun. 6, 2019

(54) AUTONOMOUS VEHICLE EMERGENCY STEERING PROFILE DURING FAILED COMMUNICATION MODES

(71) Applicant: GM GLOBAL TECHNOLOGY OPERATIONS LLC, Detroit, MI (US)

(72) Inventor: Brian N. Siskoy, Royal Oak, MI (US)

(73) Assignee: GM GLOBAL TECHNOLOGY OPERATIONS LLC, Detroit, MI (US)

(21) Appl. No.: 15/830,757

(22) Filed: Dec. 4, 2017

(51) Int. Cl. B62D 6/00; B60T 7/12; G05D 1/02; G05D 1/00

(52) U.S. Cl. CPC B62D 6/001; B60T 7/12; G05D 2201/0213; G05D 1/0055; B60T 2260/02; G05D 1/0276

(57) ABSTRACT

Methods, systems, and vehicles are provided for controlling steering in an autonomous vehicle including a communication system, a vehicle control system, and a steering control system. The vehicle control system is configured to provide initial steering instructions, via the communication system, that include a current steering command for a current time and one or more future projected steering commands for the autonomous vehicle for possible implementation at one or more future times. The steering control system includes a processor configured to implement the current steering command; determine, subsequent to the initial steering instructions, that an error has occurred with respect to the providing of steering instructions from the vehicle control system; and implement the one or more future projected steering commands for the one or more future times when it is determined that an error has occurred with respect to the providing of steering instructions from the vehicle control system.

### TECHNICAL FIELD

The present disclosure generally relates to vehicles, and more particularly relates to systems and methods for controlling steering for autonomous vehicles during a failed communication mode.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved movement of autonomous vehicles, for example in controlling steering during a failed communication mode.

Accordingly, it is desirable to provide systems and methods for controlling of steering for autonomous vehicles during a failed communication mode. Furthermore, other desirable features and characteristics of the present disclosure will become apparent from the subsequent detailed description and the appended claims, taken in conjunction with the accompanying drawings and the foregoing technical field and background.

### SUMMARY

In certain exemplary embodiments, a method is provided for controlling steering in an autonomous vehicle. The method includes providing, via a communication system, initial steering instructions from a vehicle control system to a steering control system for a steering system of the autonomous vehicle, the initial steering instructions including a current steering command for a current time and one or more future projected steering commands for the autonomous vehicle for possible implementation at one or more future times that are subsequent to the current time; implementing the current steering command via the steering system of the autonomous vehicle; determining, subsequent to the initial steering instructions, that an error has occurred with respect to the providing of steering instructions from the vehicle control system; and implementing the one or more future projected steering commands, via the steering system, for the one or more future times when it is determined that an error has occurred with respect to the providing of steering instructions from the vehicle control system

Also in certain embodiments, the step of implementing the one or more future projected steering commands includes implementing the one or more future projected steering commands when it is determined that an error has occurred with respect to the providing of steering instructions from the vehicle control system, until the autonomous vehicle is brought to a stable state.

Also in certain embodiments, the method further includes: providing, via the communication system, one or more updated steering instructions for the one or more future times, from the vehicle control system; and when it is not determined that an error has occurred with respect to the providing of steering instructions from the vehicle control system, implementing the one or more updated steering instructions, via the steering system, instead of the one or more future projected steering commands, for the one or more future times.

Also in certain embodiments, the method further includes formatting the one or more future projected steering commands into a compressed format prior to providing from the vehicle control system.

Also in certain embodiments, the method further includes interpolating the one or more future projected steering commands from the compressed format prior to implementation when it is determined that an error has occurred with respect to the providing of steering instructions from the vehicle control system.

Also in certain embodiments, the method further includes: receiving information regarding automatic braking for the autonomous vehicle when it is determined that an error has occurred with respect to the providing of steering instructions from the vehicle control system; and adjusting the one or more future projected steering commands based on the information regarding the automatic braking, generating one or more adjusted future projected steering commands, when it is determined that an error has occurred with respect to the providing of steering instructions from the vehicle control system; wherein the step of implementing the one or more adjusted future projected steering commands includes implementing the one or more adjusted future projected steering commands for the one or more future times when it is determined that an error has occurred with respect to the providing of steering instructions from the vehicle control system.

Also in certain embodiments, the step of implementing the one or more adjusted future projected steering commands includes implementing the one or more adjusted future projected steering commands for the one or more future times when it is determined that an error has occurred with respect to the providing of steering instructions from the vehicle control system, until the autonomous vehicle has been brought to a stop.

In certain other embodiments, a system for controlling steering in an autonomous vehicle is provided. The system includes a vehicle control module and a steering control module. The vehicle control module is configured to provide initial steering instructions via a communication system. The initial steering instructions include a current steering command for a current time and one or more future projected steering commands for the autonomous vehicle for possible implementation at one or more future times that are subsequent to the current time. The steering control module is configured to: implement the current steering command; determine, subsequent to the initial steering instructions, that an error has occurred with respect to the providing of steering instructions from the vehicle control module; and implement the one or more future projected steering commands for the one or more future times when it is determined that an error has occurred with respect to the providing of steering instructions from the vehicle control module.

Also in certain embodiments, the steering control module is configured to implement the one or more future projected steering commands for the one or more future times when it is determined that an error has occurred with respect to the providing of steering instructions from the vehicle control module, until the autonomous vehicle is brought to a stable state.

Also in certain embodiments, the vehicle control module is configured to provide, via the communication system, one or more updated steering instructions for the one or more future times; and the steering control module is configured, when it is not determined that an error has occurred with respect to the providing of steering instructions from the vehicle control module, to implement the one or more updated steering instructions, instead of the one or more future projected steering commands, for the one or more future times.

Also in certain embodiments, the vehicle control module is configured to format the one or more future projected steering commands into a compressed format prior to providing from the vehicle control system.

Also in certain embodiments, the steering control module is configured to interpolate the one or more future projected steering commands from the compressed format prior to implementation when it is determined that an error has occurred with respect to the providing of steering instructions from the vehicle control system.

Also in certain embodiments, the steering control module is configured to: receive information regarding automatic braking for the autonomous vehicle when it is determined that an error has occurred with respect to the providing of steering instructions from the vehicle control system; adjust the one or more future projected steering commands based on the information regarding the automatic braking, generating one or more adjusted future projected steering commands, when it is determined that an error has occurred with respect to the providing of steering instructions from the vehicle control system; and implement the one or more adjusted future projected steering commands for the one or more future times when it is determined that an error has occurred with respect to the providing of steering instructions from the vehicle control system.

Also in certain embodiments, the steering control module is configured to implement the one or more adjusted future projected steering commands for the one or more future times when it is determined that an error has occurred with respect to the providing of steering instructions from the vehicle control system, until the autonomous vehicle has been brought to a stop.

In other exemplary embodiments, an autonomous vehicle is provided. The autonomous vehicle includes a communication system, a vehicle control system, and a steering control system. The vehicle control system is configured to provide initial steering instructions via the communication system. The initial steering instructions include a current steering command for a current time and one or more future projected steering commands for the autonomous vehicle for possible implementation at one or more future times that are subsequent to the current time. The steering control system includes a processor configured to: implement the current steering command; determine, subsequent to the initial steering instructions, that an error has occurred with respect to the providing of steering instructions from the vehicle control system; and implement the one or more future projected steering commands for the one or more future times when it is determined that an error has occurred with respect to the providing of steering instructions from the vehicle control system.

Also in certain embodiments, the steering control system is configured to implement the one or more future projected steering commands for the one or more future times when it is determined that an error has occurred with respect to the providing of steering instructions from the vehicle control system, until the autonomous vehicle is brought to a stable state.

Also in certain embodiments, the vehicle control system is configured to provide, via the communication system, one or more updated steering instructions for the one or more future times; and the steering control system is configured, when it is not determined that an error has occurred with respect to the providing of steering instructions from the vehicle control system, to implement the one or more updated steering instructions, instead of the one or more future projected steering commands, for the one or more future times.

Also in certain embodiments, the vehicle control system is configured to format the one or more future projected steering commands into a compressed format prior to providing from the vehicle control system.

Also in certain embodiments, the steering control system is configured to interpolate the one or more future projected steering commands from the compressed format prior to implementation when it is determined that an error has occurred with respect to the providing of steering instructions from the vehicle control system.

Also in certain embodiments, the steering control system is configured to: receive information regarding automatic braking for the autonomous vehicle when it is determined that an error has occurred with respect to the providing of steering instructions from the vehicle control system; adjust the one or more future projected steering commands based on the information regarding the automatic braking, generating one or more adjusted future projected steering commands, when it is determined that an error has occurred with respect to the providing of steering instructions from the vehicle control system; and implement the one or more adjusted future projected steering commands for the one or more future times when it is determined that an error has occurred with respect to the providing of steering instructions from the vehicle control system, until the autonomous vehicle has been brought to a stop.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a control system that includes a vehicle control system and a steering control system for controlling steering for the autonomous vehicle during a failed communication mode;

FIG. 2 is a functional block diagram illustrating a transportation system having one or more vehicles as shown in FIG. 1, in accordance with various embodiments;

FIG. 3 is functional block diagram illustrating an autonomous driving system (ADS) having a control system associated with the vehicle of FIG. 1, in accordance with various embodiments;

FIG. 4 is a functional block diagram illustrating the control system, in accordance with various embodiments;

FIG. 5 is a flowchart for a control process for controlling steering for an autonomous vehicle during a failed communication mode, and that can be implemented in connection with the vehicle and control systems of FIGS. 1-4, in accordance with various embodiments; and

FIGS. 6-8 are graphical representations of exemplary implementations of certain steps of the control process of FIG. 5, and that can be implemented in connection with the vehicle and control system of FIGS. 1-4, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

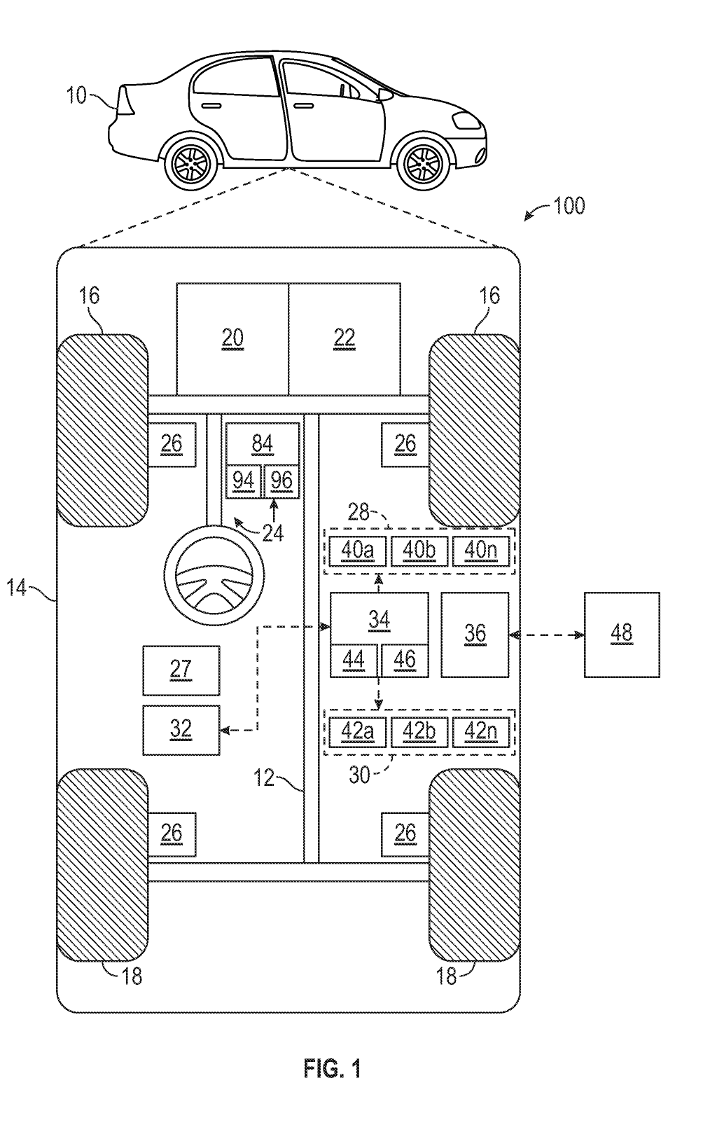

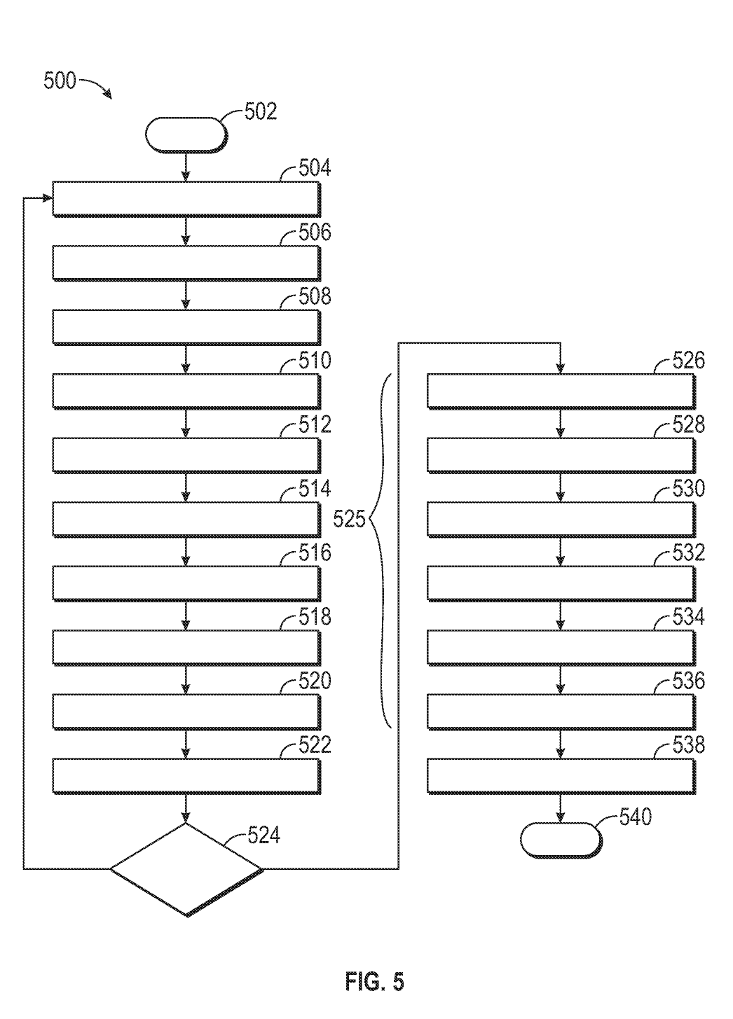

With reference to FIG. 1, a control system shown generally as 100 is associated with a vehicle 10 in accordance with various embodiments. In various embodiments, the control system 100 includes, among other features, a vehicle control system (or controller) 34 and a steering control system (or controller) 84 for a steering system 24 of the vehicle 10. In general, in various embodiments, the steering control system (or simply “system”) 100 provides control for various functionality for the vehicle 10, including for control of the steering system 24 of the vehicle 10 during a failed communication mode using data previously provided by the vehicle control system 34 to the steering control system 84, for example when an error is present for the vehicle control system 34 and/or when communications between the vehicle control system 34 and the steering control system 84 are unavailable. For example, in various embodiments, data pertaining to a projected future path of the vehicle 10, including projected future steering instructions, is provided by the vehicle control system 34 to the steering control system 84 in advance, for use in controlling steering for a limited period of time in the event that communications between the vehicle control system 34 and the steering control system 84 become unavailable, for example as described in greater detail further below in connection with the control process 500 set forth in FIG. 5.

In various embodiments, the steering system 24 influences a position of the vehicle wheels 16 and/or 18. As depicted in FIG. 1, in various embodiments, the steering system 24 includes the above-referenced steering control system 84, which in various embodiments includes one or more processors 94 and a computer-readable storage device or media (e.g., memory) 96. Also in various embodiments, the steering control system 84 receives communications from the vehicle control system 34 via the communication system 36 described further below, for example via a communication bus and/or receiver (not depicted in FIG. 1). In various embodiments, the processor 94 executes instructions using data obtained from the vehicle control system 34 (and, in certain circumstances, from one or more other vehicle systems, such as the brake system 26 discussed further below) for controlling steering for the vehicle 10 via the steering system 24. Also in various embodiments, the processor 94 may take any number of forms (including those described further below with reference to processor 44 of the vehicle control system 34), and the memory 96 may also take any number of forms (including those described further below with reference to memory 46 of the vehicle control system 34).

In addition, the steering system 24 may include one or more other steering components. While depicted as including a steering wheel for illustrative purposes, in some embodiments contemplated within the scope of the present disclosure, the steering system 24 may not include a steering wheel. In accordance with various embodiments, the steering control system 84 maintains steering for a limited time during a failed communication mode, for example when communications between the vehicle control system 34 and the steering control system 84 are unavailable, by utilizing data pertaining to a projected future path of the vehicle 10, including projected future steering instructions, provided by the vehicle control system 34 to the steering control system 84 in advance.

The vehicle control system 34 includes at least one processor 44 and a computer-readable storage device or media 46. As noted above, in various embodiments, the vehicle control system 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also in various embodiments, the vehicle control system 34 provides communications to the steering control system 84 34 via the communication system 36 described further below, for example via a communication bus and/or transmitter (not depicted in FIG. 1).

In various embodiments, the vehicle control system 34 includes at least one processor 44 and a computer-readable storage device or media 46. The processor 44 may be any custom-made or commercially available processor, a central processing unit (CPU), a graphics processing unit (GPU), an auxiliary processor among several processors associated with the vehicle control system 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the vehicle control system 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, the processor 44 may be any custom-made or commercially available processor, a central processing unit (CPU), a graphics processing unit (GPU), an auxiliary processor among several processors associated with the vehicle control system 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the vehicle control system 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes sensors and a suspension system.

As shown, the vehicle 10 generally also includes a propulsion system 20, a transmission system 22, a brake system 26, one or more user input devices 27, a sensor system 28, an actuator system 30, at least one data storage device 32, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

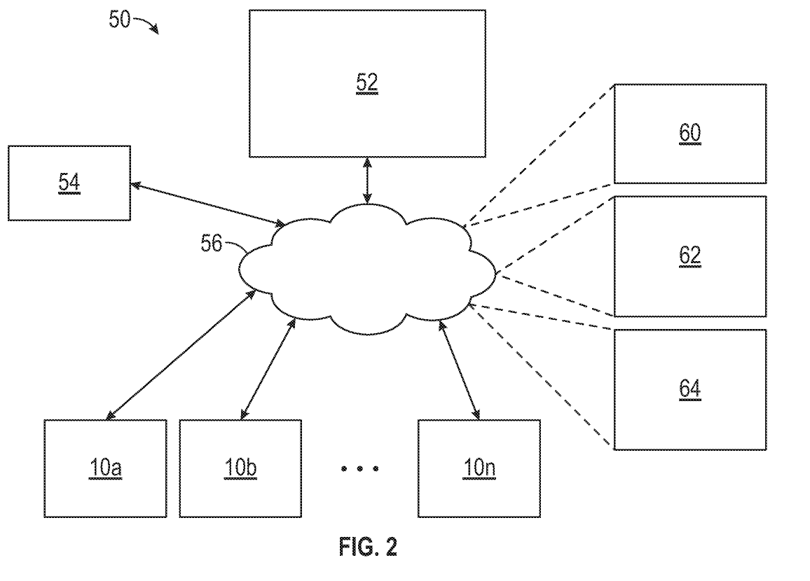

In various embodiments, one or more user input devices 27 receive inputs from one or more passengers of the vehicle 10. In various embodiments, the inputs include a desired destination of travel for the vehicle 10. In certain embodiments, one or more input devices 27 comprise an interactive touch-screen in the vehicle 10. In certain embodiments, one or more inputs devices 27 comprise a speaker for receiving audio information from the passengers. In certain other embodiments, one or more input devices 27 may comprise one or more other types of devices and/or may be coupled to a user device (e.g., smart phone and/or other electronic device) of the passengers, such as the user device 54 depicted in FIG. 2 and described further below in connection therewith).

The sensor system 28 includes one or more sensors 40a-40n that sense observable conditions of the exterior environment and/or the interior environment of the vehicle 10. The sensors 40a-40n include, but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the vehicle control system 34, separate from the vehicle control system 34, or part of the vehicle control system 34 and part of a separate system.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the vehicle control system 34 and the steering control system 84, including data pertaining to a projected future path of the vehicle 10, including projected future steering instructions. Also in various embodiments, the communication system 36 may also facilitate communications between the steering control system 84 and/or or more other systems and/or devices.

In certain embodiments, the communication system 36 is further configured for communication between the sensor system 28, the input device 27, the actuator system 30, one or more controllers (e.g., the vehicle control system 34), and/or more other systems and/or devices (such as, by way of example, the user device 54 depicted in FIG. 2 and described further below in connection therewith). For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers (e.g., the user device 54 of FIG. 2), and/or one or more sources of remote information (e.g., GPS data, traffic information, weather information, and so on).

With reference now to FIG. 2, in various embodiments, the vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more vehicles 10a-10n as described with regard to FIG. 1. In various embodiments, the operating environment 50 (all or a part of which may correspond to entities 48 shown in FIG. 1) further includes one or more user devices 54 that communicate with the vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the vehicles 10a-10n to schedule rides, dispatch vehicles 10a-10n, and the like. In various embodiments, the remote transportation system 52 stores store account information such as subscriber authentication information, vehicle identifiers, profile records, biometric data, behavioral patterns, and other pertinent sub scriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline vehicle 10 and/or a vehicle based remote transportation system 52. To this end, a vehicle and vehicle based remote transportation system can be modified, enhanced, or otherwise supplemented to provide the additional features described in more detail below.

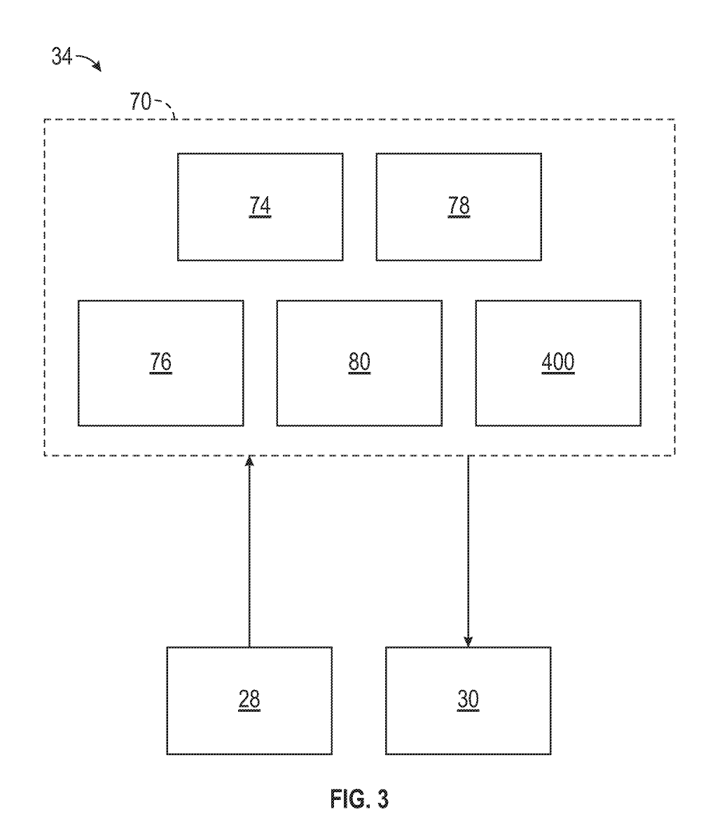

In accordance with various embodiments, the vehicle control system 34 implements an autonomous driving system (ADS) as shown in FIG. 3. That is, suitable software and/or hardware components of the vehicle control system 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, and the like) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the vehicle control system 34 implements machine learning techniques to assist the functionality of the vehicle control system 34, such as feature detection/classification, obstruction mitigation, route traversal, mapping, sensor integration, ground-truth determination, and the like.

In various embodiments, as discussed above with regard to FIG. 1, one or more instructions of the vehicle control system 34 and the steering control system 84 are embodied in the control system 100, for example for implementing a desired path for the vehicle 10 while safely controlling the vehicle 10, for example based on data and determinations made from assessing a current location of the vehicle 10, a desired destination of the vehicle 10, road conditions and possible hazards along any proposed routes, and any target vehicles in proximity to the vehicle 10 (among other possible factors), and taking appropriate action in response (e.g., by altering the path of the vehicle 10 accordingly based on the assessment), and including the use of previously-received steering data obtained by the steering control system 84 from the vehicle control system 34 when an error or failure mode has occurred with respect to communications from the vehicle control system 34 to the steering control system 84. In certain embodiments, all or parts of the control system 100 may be embodied in the computer vision system 74, and/or the vehicle control system 80 or may be implemented as a separate system (referred to as a control system 400), as shown.

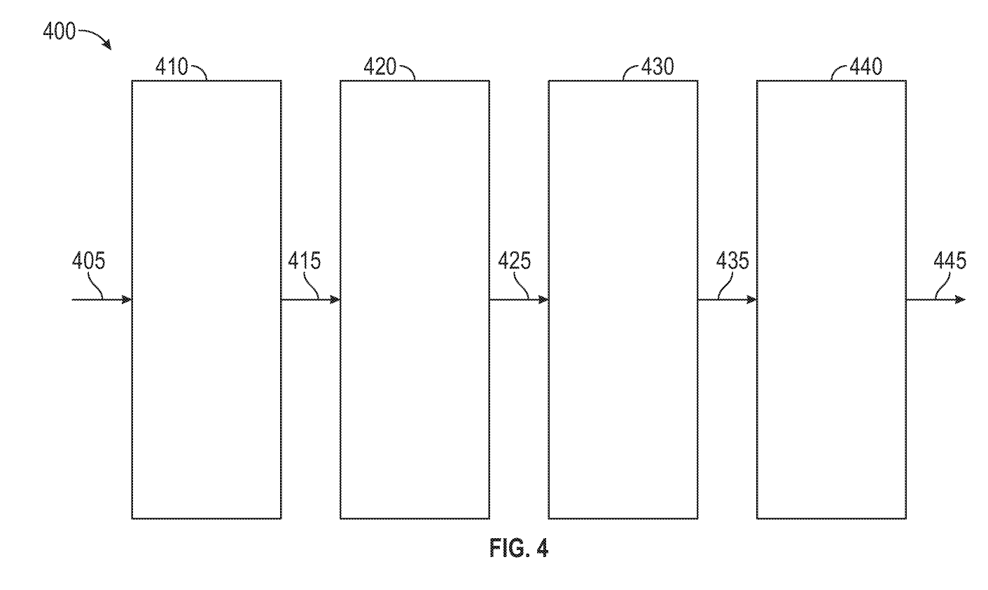

Referring to FIG. 4 and with continued reference to FIG. 1, the control system 400 generally includes a sensing module 410, a vehicle control processing module 420, a communication module 430, and a steering control processing module 440. In various embodiments, each of the sensing module 410, vehicle control processing module 420, communication module 430, and steering control processing module 440 are disposed onboard the vehicle 10. As can be appreciated, in various embodiments, parts of the control system 400 may be disposed on a system remote from the vehicle 10 while other parts of the control system 400 may be disposed on the vehicle 10.

In various embodiments, the sensing module 410 obtains data from various sensors of the vehicle 10. For example, in certain embodiments, the sensing module 410 obtains sensor data from one or more sensors 40a-40n of FIG. 1 that sense observable conditions of the exterior environment and/or the interior environment of the vehicle 10 (e.g., from one or more radars, lidars, global positioning systems, optical cameras, thermal cameras, ultrasonic sensors, inertial measurement units, and/or other sensors of the vehicle 10). Also in certain embodiments, the sensing module 410 receives sensor data as inputs 405, and provides the sensor data as outputs 415 to the vehicle control processing module 420 (e.g., via the communication system 36 of FIG. 1).

In various embodiments, the vehicle control processing module 420 receives the sensor data as inputs 415, and processes the sensor data (among other types of data, in certain embodiments). In various embodiments, the vehicle control processing module 420 processes the sensor data along with inputs from a user of the vehicle 10 (e.g., as to a desired destination of travel), and in certain embodiments other data (e.g., from a weather service, navigation system, traffic report service, and/or data from one or more other third parties and/or sources), and generates steering instructions based on the data. In various embodiments, the vehicle control processing module 420 generates a projected future path of the vehicle 10 and associated steering instructions, including current steering instructions and projected future steering instructions (e.g., including a current steering angle command for a current point or period of time and future projected future steering angle commands for future points or periods of time).

Also in various embodiments, the vehicle control processing module 420 provides the steering instructions (including the current steering instructions and projected future steering instructions) as outputs 425, to be sent to the steering control processing module 440 via the communication module 430. Specifically, in various embodiments, the steering instructions (including the current steering instructions and projected future steering instructions) are provided along the communication module 430 and are received at the steering control processing module 440 as inputs 435 for the steering control processing module 440.

Also in various embodiments, the steering control processing module 440 controls steering for the vehicle 10 based on the data provided as inputs 435 to the steering control processing module (e.g., including the current steering instructions and projected future steering instructions obtained from the vehicle control processing module 420 via the communication module 430). In various embodiments, the steering control processing module continues to receive and implement current steering angle commands at various points or periods of time from the vehicle control processing module 420 provided that communications remain valid between the vehicle control processing module 420 and the steering control processing module 440. Also in various embodiments, when an error or failure mode exists for communications between the vehicle control processing module 420 and the steering control processing module 440, then the steering control processing module 440 controls steering for the vehicle 10 based instead on previously-obtained projected future steering instructions from the vehicle control processing module 420). In either case, in various embodiments, the appropriate steering commands are implemented by the steering control processing module 440 via instructions provided as outputs 445 to a steering wheel, steering column, and/or one or more other components, actuators, and/or devices of the steering system 24 of FIG. 1.

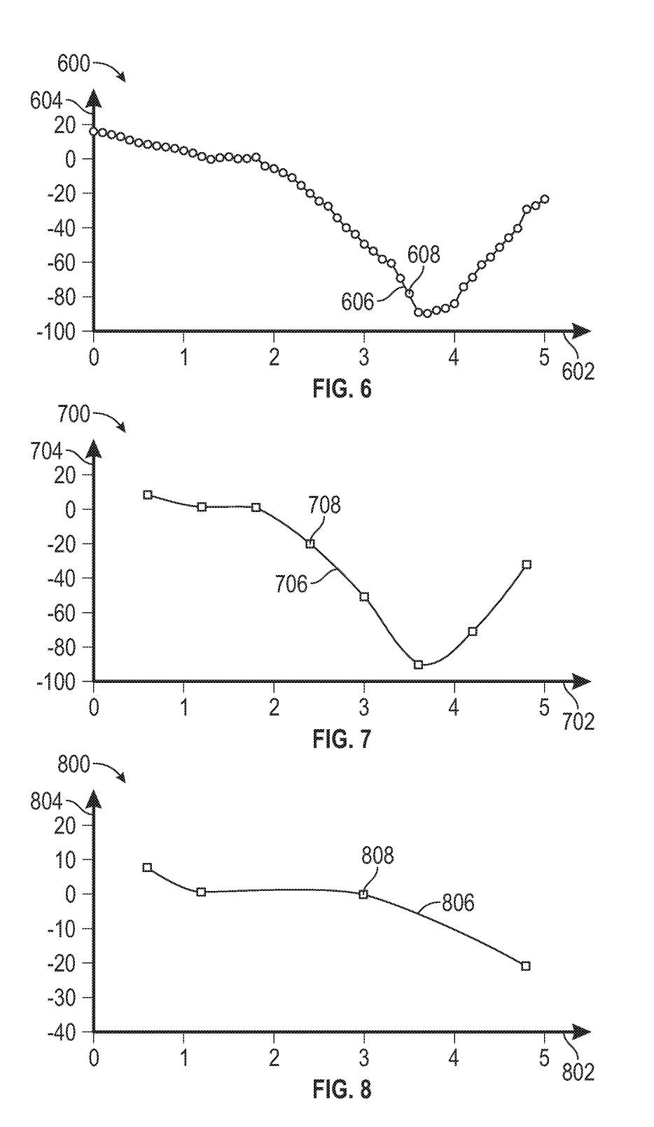

Turning now to FIG. 5, a flowchart for a control process 500 is provided for controlling steering for an autonomous vehicle during a failed communication mode, in accordance with exemplary embodiments. In various embodiments, the control process can be implemented in connection with the vehicle 10, steering system 24, brake system 26, vehicle control system 34, steering control system 84, and control systems 100, 400 of FIGS. 1-4, in accordance with various embodiments. Also in various embodiments, the control process 500 is also described below in connection with FIGS. 6-8, which provide graphical representations of exemplary implementations of the control process 500 of FIG. 5.

As can be appreciated in light of the disclosure, the order of operation within the control process 500 is not limited to the sequential execution as illustrated in FIG. 5, but may be performed in one or more varying orders as applicable and in accordance with the present disclosure. In various embodiments, the control process 500 can be scheduled to run based on one or more predetermined events, and/or can run continuously during operation of the vehicle 10.

In various embodiments, the control process 500 may begin at 502. In various embodiments, step 502 occurs when an occupant is within the vehicle 10 and the vehicle 10 begins operation in an automated manner.

Passenger inputs are obtained at 504. In various embodiments, the passenger inputs pertain to a desired destination for travel via the vehicle 10. In various embodiments, the user inputs may be obtained via an input device of the vehicle (e.g., corresponding to the input device 27 of FIG. 1) and/or a passenger device (e.g., the user device 54 of FIG. 2).

Sensor data is obtained at 506. In various embodiments, sensor data is obtained from the sensing module 410 of FIG. 4 (e.g., via the various sensors 40a . . . 40n of FIG. 1). For example, in various embodiments, sensor data is obtained from cameras and/or other visions systems, lidar sensors, radar sensors, and/or one or more other sensors. Also in various embodiments, the sensor data may pertain to data observations pertaining to surroundings for the vehicle 10 as it travels along a roadway, including information as to other vehicles that may be in proximity to the vehicle 10, along with information as to a surrounding roadway, any surrounding intersections, and surrounding hazards (e.g., barriers and/or cliffs), and the like. Also in certain embodiments, the sensor data of 506 is obtained via the sensing module 410 of FIG. 4, and corresponding outputs are provided as sensor data 415 to the vehicle control processing module 420 for processing.

Map data is obtained at 508. In various embodiments, map data is retrieved from a memory, such as the data storage devices 32 and/or 46 of FIG. 1, onboard the vehicle 10. In certain embodiments, the map data may be retrieved from the route database 53 of the autonomous vehicle based remote transportation system 52 of FIG. 2. Also in various embodiments, the map data comprises maps and associated data pertaining to roadways that are near the vehicle 10 and/or that are near or on the way from the vehicle 10's current to its destination (e.g., per the passenger inputs).

In various embodiments, other data is obtained at 510. In various embodiments, the other data is obtained at 510 via the communication system 36 of FIG. 1 (e.g., from a transceiver thereof) from or utilizing one or more remote data sources. By way of example, in certain embodiments, the other data of 510 may include GPS data using one or more GPS satellites, including the present location of the vehicle 10; data regarding applicable traffic flows and patterns for the roadways, traffic light histories, histories of movement of nearby stationary vehicles, and/or weather, construction, and/or other data from one or more remote sources that may have an impact on the analysis of the target vehicle. In various embodiments, passengers of the vehicle 10 may also provide information as to the nearby vehicles and/or their surroundings, for example via the input device 27 of FIG. 1 and/or the user device 54 of FIG. 2.

A path for the autonomous vehicle is planned and implemented at 512. In various embodiments, the path is generated and implemented via the ADS 70 of FIG. 3 for the vehicle 10 of FIG. 1 to reach a requested destination, using the passenger inputs of 504 and the map data of 508, for example via automated instructions provided by the processor 44 of FIG. 1. In various embodiments, the path of 512 comprises a path of movement of the vehicle 10 that would be expected to facilitate movement of the vehicle 10 to the intended destination while maximizing an associated score and/or desired criteria (e.g., minimizing driving time, maximizing safety and comfort, and so on). It will be appreciated that in various embodiments the path may also incorporate other data, for example such as the sensor data of 506 and/or the other data of 510. Also in certain embodiments, the path is planned via the vehicle control processing module 420 of FIG. 4 (e.g., via the processor 44 of FIG. 1).

Current steering instructions are determined at 514. In various embodiments, a current steering angle command is determined that would achieve a current portion of the desired path of 512 (e.g., corresponding to a current point or period of time). Also in various embodiments, the current steering angle command is determined via the vehicle control processing module 420 of FIG. 4 (e.g., via the processor 44 of FIG. 1).

Future projected steering instructions are determined at 516. In various embodiments, future projected steering angle commands are determined that would achieve a future portion of the desired path of 512 (e.g., corresponding to a future point or period of time that is subsequent to the current point or period of time), for use in the case of an event of a communication failure mode. Also in various embodiments, the future projected steering angle commands are determined via the vehicle control processing module 420 of FIG. 4 (e.g., via the processor 44 of FIG. 1).

In various embodiments, the future projected steering instructions of 516 are formatted at 518. In various embodiments, the future projected steering angle commands are formatted into a condensed format (e.g., including future projected steering angle commands at certain but not all future time points or periods, with gaps in between) in order to conserve message space and/or loads. Also in various embodiments, the formatting of 518 is performed via the vehicle control processing module 420 of FIG. 4 (e.g., via the processor 44 of FIG. 1).

The steering instructions are provided at 520. In various embodiments, the current steering instructions of 514 and the future projected steering instructions of 516/518 (e.g., as formatted at 518) are provided, simultaneously, by the vehicle control processing module 420 of FIG. 4 (e.g., via the using the vehicle control system 34 of FIG. 1) to the steering control processing module 440 of FIG. 4 (e.g., via the steering control system 84 of FIG. 1) via the communication module 430 of FIG. 4 (e.g., via the communication system 36 of FIG. 1). For example, in various embodiments, the current steering instructions and future projected steering instructions are transmitted via the vehicle control processing module 420 of FIG. 4 (e.g., via the using the vehicle control system 34 of FIG. 1) and received by the steering control processing module 440 of FIG. 4 (e.g., via the steering control system 84 of FIG. 1).

The current steering instructions are implemented at 522. In various embodiments, the steering control processing module 440 of FIG. 4 implements the current steering angle command of 514 (and received at 520) for the current point or period of time. Also in various embodiments, such instructions are provided as outputs 445 of FIG. 4 (e.g., that are provided to a steering wheel, steering column, and/or one or more other components, actuators, and/or devices of the steering system 24 of FIG. 1).

A determination is made at 524 as to whether a communication failure has occurred. In various embodiments, a communication failure is deemed to have occurred if there is a detected error in the operation of and/or values generated by the vehicle control processing module 420 of FIG. 4 (and/or the vehicle control system 34 of FIG. 1) and/or a detected error in communications between vehicle control processing module 420 (and/or the vehicle control system 34 of FIG. 1) and the steering control processing module 440 of FIG. 1 (and/or the steering control system 84 of FIG. 1) (e.g., in certain embodiments, an error would be detected when expected communications were not received). In various embodiments, this determination is made by the steering control processing module 440 of FIG. 4 (e.g., via the processor 94 of FIG. 1).

If a determination is not made at 524 that a communication failure has occurred, then the process returns to step 502. In various embodiments, steps 502-524 thereafter repeat until a determination is made during a subsequent iteration of 524 that a communication failure has occurred. Accordingly, provided that there are no communication failures, current steering instructions (e.g., current steering angle commands) continue to be updated and implemented, in certain embodiments continuously and in real time.

When a determination is made at 524 that a communication mode has occurred, then the future projected steering instructions are instead implemented for steering of the vehicle 10 at 525, for example as described below. In various embodiments, 525 represents a combined step (or sequence of steps) that include one or more (or all) of 526-538, as described below.

In various embodiments, the future projected steering instructions are retrieved at 526. In various embodiments, the steering control processing module 440 of FIG. 4 retrieves the future projected steering angle commands of steps 516/518 (e.g., as formatted at 518 and received at 520), for example from a memory (such as memory 96 of FIG. 1).

Also in various embodiments, braking is initiated at 528. In various embodiments, one or more control systems of the vehicle 10 (e.g., the vehicle control system 34 of FIG. 1) initiates emergency braking for the vehicle 10 via brake system 26 of FIG. 1.

In addition, in various embodiments, braking data is obtained at 530. In various embodiments, information as to the amount of emergency braking (and its effect on movement, including velocity and acceleration of the vehicle 10) is provided to the steering control processing module 440 for processing in combination with the future projected steering angle commands. In certain embodiments, when a failure has occurred at an ADIM level (e.g., a fault with respect to the communication module 430 and/or outputs 435 therefrom) and not at an EPS connector level, then real-time braking data can be utilized. Also in various embodiments, if a failure occurs at the EPS connector level (e.g., meaning that no communication is being received from any other modules), then a default expected braking profile may instead be utilized.

Also in various embodiments, the formatted future projected steering instructions are interpreted at 532. For example, in various embodiments in which the future projected steering angle commands were compressed as part of the formatting of 518, interpolation is performed to ascertain projected intermediate steering angle commands between points in the data. Also in various embodiments, this interpretation (e.g., interpolation) is performed by the steering control processing module 440 of FIG. 4 (e.g., via the processor 94 of FIG. 1).

Also in various embodiments, the future projected steering instructions are adjusted at 534 based on the braking data. In various embodiments, the future projected steering angle commands (e.g., after the interpolation and/or other interpretation of 532) are adjusted at 534 to account for the amount of emergency braking that is being provided for the vehicle 10. For example, in certain embodiments, the adjustments may compensate for an effect of the braking on lateral movement of the vehicle 10. By way of additional example, in certain embodiments, the adjustments may account for changes in distances between the vehicle 10 and other vehicles, objects, or hazards (e.g., a barrier, a cliff, or the like) due to reduced speed and/or acceleration of the vehicle 10 due to the emergency braking. In certain embodiments, this can help to prevent contact between the vehicle 10 and such other vehicles, objects, or hazards. For example, in certain embodiments, if the adjustment had not been made to compensate for the new vehicle speed profile, the vehicle 10 would not have correctly avoided the hazards (including curved roads) that it was originally projected to avoid (and therefore the adjustments can help to overcome this problem).

The future projected steering instructions are implemented at 536. In various embodiments, the steering control processing module 440 of FIG. 4 implements the future projected steering commands (e.g., as interpreted, modified, and/or adjusted at 532, 534, and/or 536) for the future points or periods in time (e.g., after the point or period of time that was previously considered the “current” point or period in time). Also in various embodiments, such instructions are provided as outputs 445 of FIG. 4 (e.g., that are provided to a steering wheel, steering column, and/or one or more other components, actuators, and/or devices of the steering system 24 of FIG. 1).

In various embodiments, the vehicle is brought to a safe state at 538. For example, in various embodiments, the vehicle 10 is brought to stop via the automatic braking. Also in various embodiments, the future projected steering instructions are implemented at 536 until the vehicle reaches the stable state 538. Also in various embodiments, the control process 500 then terminates at 540.

Accordingly, in various embodiments, during the control process 500 of FIG. 5, a vehicle control module and/or system provides (at 520) initial steering instructions to a steering control module and/or system at various points in time, that include both a current steering command for a current time (i.e., corresponding to 514) and one or more future projected steering commands for the autonomous vehicle (i.e., corresponding to 516/518) for possible implementation at one or more future times that are subsequent to the current time. Also in various embodiments, when no communication error is determined, new/updated values of the current steering command and the future projected commands continue to be provided at various iterations of 520, and current steering instructions (e.g., current steering angle commands) continue to be updated and implemented, in certain embodiments continuously and in real time. However, once an error has been detected (i.e., subsequent at least to the initial steering instructions), steering is implemented instead using the one or more future projected steering commands that were received prior to the communication error. In various embodiments, the future projected steering commands are utilized to bring the vehicle 10 to a safe state (e.g., to a vehicle 10 stop brought about via the emergency braking). For example, in various embodiments, while the emergency braking is being applied, the vehicle 10 steering will be controlled implemented using the future steering angle commands in order to help avoid any cliffs, other vehicles or objects, and/or other hazards (based on the previously determined path including portions covering the future points or periods of time) until the vehicle 10 reaches a safe state. In certain embodiments, the process 500 applies particularly to an object that was previously detected before the communication fault occurred, rather than a new object that was not previously detected before the communication fault occurred.

FIGS. 6-8 are graphical representations of exemplary implementations of certain steps of the control process 500 of FIG. 5, in accordance with certain exemplary embodiments. Also in accordance with certain exemplary embodiments, these may be implemented in connection with the vehicle and control systems of FIGS. 1-4.

FIG. 6 provides a first graphical representation 600 of certain steps of the process 500 of FIG. 5, in accordance with exemplary embodiments. Specifically, graphical representation 600 illustrates exemplary future projected steering commands of step 516 of FIG. 5, in accordance with certain exemplary embodiments. As shown in FIG. 6, graphical representation 600 includes a graphical function 606 with various projected steering command points 608 at various future points in time, in accordance with certain exemplary embodiments. Also in certain embodiments, the x-axis 602 represents time (e.g., in seconds), the y-axis 604 represents a steering angle command (e.g., in degrees), and the graphical function 606 and points 608 represent raw steering angles.

FIG. 7 provides a second graphical representation 700 of certain steps of the process 500 of FIG. 5, in accordance with exemplary embodiments. Specifically, graphical representation 700 illustrates exemplary future projected steering commands as formatted in step 518 of FIG. 5, in accordance with certain exemplary embodiments. As shown in FIG. 7, graphical representation 700 includes a graphical function 706 with various steering command points 708 at various future points in time, in accordance with certain exemplary embodiments. Also in certain embodiments, the x-axis 702 represents time (e.g., in seconds), the y-axis 704 represents a steering angle command (e.g., in degrees), and the graphical function 706 and points 708 represent formatted raw steering angles. As shown in FIG. 7, in various embodiments the formatted future projected steering commands of 516 have fewer steering command points 708 as compared with the steering command points 608 of FIG. 6, due to the compressing of the data during the formatting of the future projected steering commands in 518.

FIG. 8 provides a third graphical representation 800 of certain steps of the process 500 of FIG. 5, in accordance with exemplary embodiments. Specifically, graphical representation 800 illustrates exemplary future projected steering commands as adjusted for braking data in step 530 of FIG. 5, in accordance with certain exemplary embodiments. As shown in FIG. 8, graphical representation 800 includes a graphical function 806 with various steering command points 808 at various future points in time that have been adjusted due to the data pertaining to the emergency braking for the vehicle 10. Also in certain embodiments, the x-axis 802 represents time (e.g., in seconds), the y-axis 804 represents a steering angle command (e.g., in degrees), and the graphical function 806 and points 808 represent formatted raw steering angles. As shown in FIG. 8, in various embodiments the future projected steering commands may be smoothed out in various embodiments due to the deceleration of the vehicle 10 as a result of the emergency braking, which for example will lead the vehicle 10 to a stable state more rapidly than if emergency braking were not implemented.

As mentioned briefly, the various modules and systems described above may be implemented as one or more machine learning models that undergo supervised, unsupervised, semi-supervised, or reinforcement learning. Such models might be trained to perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), and linear discriminant analysis models.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling steering in an autonomous vehicle, the method comprising:
providing, via a communication system, initial steering instructions from a vehicle control system to a steering control system for a steering system of the autonomous vehicle, the initial steering instructions comprising a current steering command for a current time and one or more future projected steering commands for the autonomous vehicle for possible implementation at one or more future times that are subsequent to the current time;
implementing the current steering command via the steering system of the autonomous vehicle;
determining, subsequent to the initial steering instructions, that an error has occurred with respect to the providing of steering instructions from the vehicle control system; and
implementing the one or more future projected steering commands, via the steering system, for the one or more future times when it is determined that an error has occurred with respect to the providing of steering instructions from the vehicle control system.

2. The method of claim 1, wherein the step of implementing the one or more future projected steering commands comprises implementing the one or more future projected steering commands when it is determined that an error has occurred with respect to the providing of steering instructions from the vehicle control system, until the autonomous vehicle is brought to a stable state.

3. The method of claim 1, further comprising:
providing, via the communication system, one or more updated steering instructions for the one or more future times, from the vehicle control system; and
when it is not determined that an error has occurred with respect to the providing of steering instructions from the vehicle control system, implementing the one or more updated steering instructions, via the steering system, instead of the one or more future projected steering commands, for the one or more future times.

4. The method of claim 1, further comprising:
formatting the one or more future projected steering commands into a compressed format prior to providing from the vehicle control system.

5. The method of claim 4, further comprising:
interpolating the one or more future projected steering commands from the compressed format prior to implementation when it is determined that an error has occurred with respect to the providing of steering instructions from the vehicle control system.

6. The method of claim 1, further comprising:
receiving information regarding automatic braking for the autonomous vehicle when it is determined that an error has occurred with respect to the providing of steering instructions from the vehicle control system; and
adjusting the one or more future projected steering commands based on the information regarding the automatic braking, generating one or more adjusted future projected steering commands, when it is determined that an error has occurred with respect to the providing of steering instructions from the vehicle control system;
wherein the step of implementing the one or more adjusted future projected steering commands comprises implementing the one or more adjusted future projected steering commands for the one or more future times when it is determined that an error has occurred with respect to the providing of steering instructions from the vehicle control system.

7. The method of claim 6, wherein the step of implementing the one or more adjusted future projected steering commands comprises implementing the one or more adjusted future projected steering commands for the one or more future times when it is determined that an error has occurred with respect to the providing of steering instructions from the vehicle control system, until the autonomous vehicle has been brought to a stop.

8. A system for controlling steering in an autonomous vehicle, the system comprising:
a vehicle control module configured to provide initial steering instructions via a communication system, the initial steering instructions comprising a current steering command for a current time and one or more future projected steering commands for the autonomous vehicle for possible implementation at one or more future times that are subsequent to the current time; and
a steering control module configured to:
implement the current steering command;
determine, subsequent to the initial steering instructions, that an error has occurred with respect to the providing of steering instructions from the vehicle control module; and
implement the one or more future projected steering commands for the one or more future times when it is determined that an error has occurred with respect to the providing of steering instructions from the vehicle control module.

9. The system of claim 8, wherein the steering control module is configured to implement the one or more future projected steering commands for the one or more future times when it is determined that an error has occurred with respect to the providing of steering instructions from the vehicle control module, until the autonomous vehicle is brought to a stable state.

10. The system of claim 8, wherein:
the vehicle control module is configured to provide, via the communication system, one or more updated steering instructions for the one or more future times; and
the steering control module is configured, when it is not determined that an error has occurred with respect to the providing of steering instructions from the vehicle control module, to implement the one or more updated steering instructions, instead of the one or more future projected steering commands, for the one or more future times.

11. The system of claim 8, wherein the vehicle control module is configured to format the one or more future projected steering commands into a compressed format prior to providing from the vehicle control system.

12. The system of claim 11, wherein the steering control module is configured to interpolate the one or more future projected steering commands from the compressed format prior to implementation when it is determined that an error has occurred with respect to the providing of steering instructions from the vehicle control system.

13. The system of claim 8, wherein the steering control module is configured to:
receive information regarding automatic braking for the autonomous vehicle when it is determined that an error has occurred with respect to the providing of steering instructions from the vehicle control system;
adjust the one or more future projected steering commands based on the information regarding the automatic braking, generating one or more adjusted future projected steering commands, when it is determined that an error has occurred with respect to the providing of steering instructions from the vehicle control system; and
implement the one or more adjusted future projected steering commands for the one or more future times when it is determined that an error has occurred with respect to the providing of steering instructions from the vehicle control system.

14. The system of claim 13, wherein the steering control module is configured to implement the one or more adjusted future projected steering commands for the one or more future times when it is determined that an error has occurred with respect to the providing of steering instructions from the vehicle control system, until the autonomous vehicle has been brought to a stop.

15. An autonomous vehicle comprising:
a communication system;
a vehicle control system configured to provide initial steering instructions via the communication system, the initial steering instructions comprising a current steering command for a current time and one or more future projected steering commands for the autonomous vehicle for possible implementation at one or more future times that are subsequent to the current time; and
a steering control system comprising a processor configured to:
implement the current steering command;
determine, subsequent to the initial steering instructions, that an error has occurred with respect to the providing of steering instructions from the vehicle control system; and
implement the one or more future projected steering commands for the one or more future times when it is determined that an error has occurred with respect to the providing of steering instructions from the vehicle control system.

16. The autonomous vehicle of claim 15, wherein the steering control system is configured to implement the one or more future projected steering commands for the one or more future times when it is determined that an error has occurred with respect to the providing of steering instructions from the vehicle control system, until the autonomous vehicle is brought to a stable state.

17. The autonomous vehicle of claim 15, wherein:
the vehicle control system is configured to provide, via the communication system, one or more updated steering instructions for the one or more future times; and
the steering control system is configured, when it is not determined that an error has occurred with respect to the providing of steering instructions from the vehicle control system, to implement the one or more updated steering instructions, instead of the one or more future projected steering commands, for the one or more future times.

18. The autonomous vehicle of claim 15, wherein the vehicle control system is configured to format the one or more future projected steering commands into a compressed format prior to providing from the vehicle control system.

19. The autonomous vehicle of claim 18, wherein the steering control system is configured to interpolate the one or more future projected steering commands from the compressed format prior to implementation when it is determined that an error has occurred with respect to the providing of steering instructions from the vehicle control system.

20. The autonomous vehicle of claim 15, wherein the steering control system is configured to:
receive information regarding automatic braking for the autonomous vehicle when it is determined that an error has occurred with respect to the providing of steering instructions from the vehicle control system;
adjust the one or more future projected steering commands based on the information regarding the automatic braking, generating one or more adjusted future projected steering commands, when it is determined that an error has occurred with respect to the providing of steering instructions from the vehicle control system; and
implement the one or more adjusted future projected steering commands for the one or more future times when it is determined that an error has occurred with respect to the providing of steering instructions from the vehicle control system, until the autonomous vehicle has been brought to a stop.
